(19) United States
(12) Patent Application Publication
(10) Pub. No.: US 2007/0096657 A1
(43) Pub. Date: May 3, 2007

(54) PLASMA LIGHTING SYSTEM AND DRIVING CONTROL METHOD THEREOF

(75) Inventors: Yun-Chul JUNG, Gyeonggi-Do (KR); Joon-Sik CHOI, Seoul (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 11/554,148

(22) Filed: Oct. 30, 2006

(30) Foreign Application Priority Data
Oct. 31, 2005 (KR) 10-2005-0103570

(51) Int. Cl. H01J 25/50

(52) U.S. Cl. 315/39.51

(57) ABSTRACT

A plasma lighting system includes a controller that outputs a first switching control signal to drive a filament of a magnetron, and outputs a second switching control signal to drive an anode of the magnetron. A first converter converts a direct current (DC) voltage into an alternating current (AC) voltage based on the first switching control signal. A second converter converts a DC voltage into an AC voltage based on the second switching control signal.

### RELATED APPLICATION

The present disclosure relates to subject matter contained in priority Korean Application No. 10-2005-0103570, filed on Oct. 31, 2005, which is herein expressly incorporated by reference in its entirety.

### BACKGROUND OF THE INVENTION

1. Field of the invention

The present invention relates to a plasma lighting system, and more particularly, to a plasma lighting system capable of enhancing a stability of an inverter lighting device and a driving control method thereof.

2. Description of the Background Art

Generally, a plasma lighting system (PLS) is a lighting device in which first, high frequency microwaves are generated by a magnetron of a high frequency oscillator, to convert an inert gas in a bulb into a plasma, which is an ionized status. The above plasma status is maintained to make a metal compound in the bulb emit light continuously, thereby proving a high quantity of light without an electrode.

Since light is emitted by the light emitting principle of the plasma without a filament, the plasma lighting system can be used for a long time without lowering a flux.

Also, since a continuous optical light spectrum is comparable to natural white-light, the appearance of the light emitted by the plasma lighting system is similar to sun light.

Furthermore, the plasma lighting system does not use a fluorescent material to protect visual acuity, and is able to minimize radiation of ultraviolet rays and infrared rays to provide a comfortable and eco-friendly lighting environment.

FIG. 1 is a block diagram illustrating an example of a plasma lighting system.

As shown in FIG. 1, the plasma lighting system comprises a power unit 1, a rectifying unit 2, a half-bridge inverter 3, a controlling unit 4, a transforming unit 5, a high voltage generating unit 6, and a magnetron 7.

The power unit 1 supplies an alternating current (AC) voltage to the plasma lighting system.

The rectifying unit 2 rectifies and smoothes the AC voltage inputted through the power unit 1 to output a direct current (DC) voltage therefrom.

The half-bridge inverter 3 inverts the DC voltage outputted from the rectifying unit 2 by a switching control signal to output an AC voltage therefrom.

The controlling unit 4 outputs the switching control signal to alternately switch a first transistor S1 and a second transistor S2 of the half bridge inverter 3 (See FIG. 2).

The transforming unit 5 transforms an AC voltage outputted from the half-bridge inverter 3.

More concretely, the transforming unit 5 transforms an AC voltage outputted from the half-bridge inverter 3 based on a preset winding ratio of a first coil thereof, and then applies the transformed AC voltage to a second coil thereof.

The high voltage generating unit 6 boosts the AC voltage applied to a second coil of the transforming unit 5, thereby generating a high voltage.

The magnetron 7 is driven by a high voltage generated from the high voltage generating unit 6, thereby generating microwaves.

FIG. 2 is a circuit diagram showing the plasma lighting system of FIG. 1 in greater detail, and FIG. 3 is a waveform showing an operation of the plasma lighting system.

Referring to FIGS. 2 and 3, the controlling unit 4 alternately applies a switching control signal to gates G1 and G2 of the first transistor S1 and second transistor S2, respectively, of the half-bridge inverter 3. Then, the controlling unit 4 increases or decreases a resonance voltage and a current according to an on/off period of the switching control signal.

A voltage and a current applied to a first coil of the transforming unit 5 are indicated as ‘V1’ and ‘i1’ in FIG. 3. Based on the voltage V1 and the current i1 applied to the first coil, a voltage Vd rectified by the rectifying unit 2 is applied to the first transistor S1 and a negative voltage (−Vd) of the voltage Vd is applied to the second transistor S2.

The current ‘i1’ applied to the first coil of the transforming unit 5 is shown in FIG. 3.

The high voltage generating unit 6 boosts a voltage applied to a second coil of the transforming unit 5 through a capacitor C, diodes D1 and D2, and a resistor R, and supplies a high voltage to the magnetron (MGT) 7.

The magnetron (MGT) 7 utilizes the inputted high voltage as a driving voltage to generate microwaves.

The microwaves resonated in the magnetron (MGT) 7 are applied to a bulb through a wave guide and a resonator. Gas inside the bulb is converted to plasma due to electron collisions, thus emitting light.

However, in related art plasma lighting systems, an integral type trans-inverter for driving a filament of a magnetron and generating a high voltage so as to drive an anode of the magnetron is applied. Accordingly, the anode of the magnetron has to be driven by a high voltage before the filament is heated. Further, the integral type trans-inverter has to be molded under a state that an insulation distance is obtained with consideration of an insulation voltage.

### SUMMARY OF THE INVENTION

Therefore, an object of the present invention is to provide a plasma lighting system capable of enhancing a stability of an inverter by separately implementing a transformer for driving a cathode filament of a magnetron and a transformer for generating a high voltage to drive an anode of the magnetron, and a driving control method thereof.

To achieve these and other advantages and in accordance with the purpose of the present invention, as embodied and broadly described herein, there is provided a plasma lighting system which includes a controller which outputs a first switching control signal which drives a filament of a magnetron, and outputs a second switching control signal which drives an anode of the magnetron, a first converter which converts a direct current (DC) voltage into an alternating current (AC) voltage based on the first switching control signal, and a second converter which converts a DC voltage into an AC voltage based on the second switching control signal.

The controller may output the first switching control signal and the second switching control signal with a certain time interval therebetween. The controller may output the first switching control signal, and then output the second switching control signal after a certain time. The first switching control signal and the second switching control signal may have the same duty cycle.

The first converter may include a Class-E resonance inverter. The second converter may include a half-bridge inverter.

There is also provided a plasma lighting system which includes a controller which outputs a first switching control signal which drives a filament of a maqnetron and a second switching control signal which drives an anode of the magnetron, a first converter which converts a direct current (DC) voltage into an alternating current (AC) voltage based on the first switching control signal, a second converter which converts a DC voltage into an AC voltage based on the second switching control signal, a first transformer which transforms the AC voltage converted by the first converter to a first AC voltage of a preset level, and supplies the filament of the magnetron with the transformed first AC voltage, and a second transformer which transforms the AC voltage converted by the second converter to a second AC voltage of a preset voltage, and supplies the anode of the magnetron with the transformed second AC voltage.

There is also provided a driving control method for a plasma lighting system which includes heating a filament of a magnetron, and driving an anode of the magnetron when the filament of the magnetron is heated for a certain time, thereby generating microwaves.

Heating the filament of the magnetron may include generating an alternating current (AC) voltage by a first converter, transforming the AC voltage generated by the first converter into a voltage of a preset level, and supplying the transformed voltage of a preset level to the filament of the magnetron.

Driving the anode of the magnetron may include generating an alternating current (AC) voltage by a second converter, transforming the AC voltage generated by second converter into a voltage of a preset level, boosting the transformed voltage of a preset level into a high voltage, and supplying the high voltage to the anode of the magnetron.

There is also provided a driving control method for a plasma lighting system which includes generating a first alternating current (AC) voltage by a first converter, transforming the first AC voltage into a first transformed voltage of a preset level, supplying the first transformed voltage to a filament of a magnetron, generating a second AC voltage by a second converter when a certain time lapses after generating the first AC voltage, transforming the second AC voltage into a second transformed voltage of a preset level, boosting the second transformed voltage into a high voltage, and supplying an anode of the magnetron with the high voltage, thereby generating microwaves.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention, in which:

FIG. 1 illustrates a block diagram showing an example of a plasma lighting system;

FIG. 2 illustrates a circuit diagram of the plasma lighting system of FIG. 1;

FIG. 3 illustrates waveforms associated with the plasma lighting system of FIG. 1;

FIG. 4 illustrates a circuit diagram of a plasma lighting system according to an example of the present invention;

FIG. 5 is a waveform showing each component of FIG. 4; and

FIG. 6 is a flowchart showing a driving control method for the plasma lighting system according to the present invention.

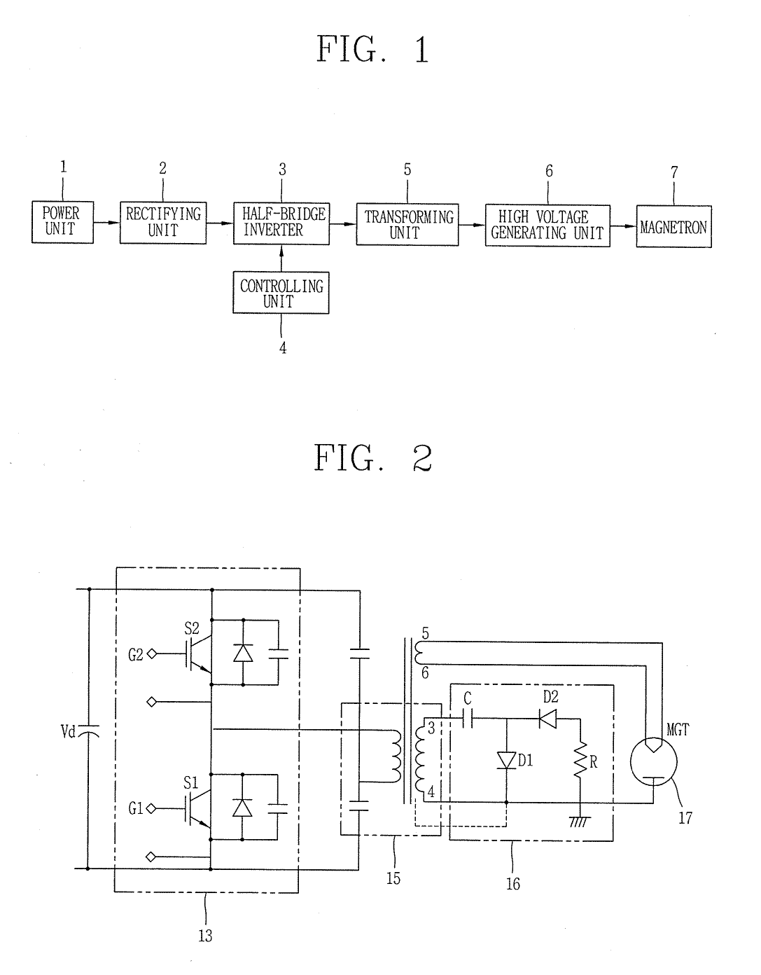

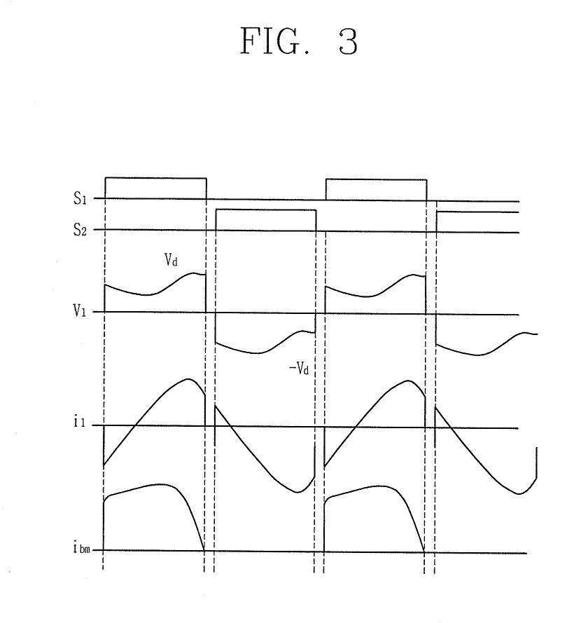

### DETAILED DESCRIPTION OF THE INVENTION

Reference will now be made in detail to preferred embodiments of the present invention, examples of which are illustrated in the accompanying drawings.

Hereinafter, a plasma lighting system capable of enhancing a stability of an inverter by separately implementing a transformer for driving a cathode filament of a magnetron and a transformer for generating a high voltage to drive an anode of the magnetron, and a driving control method thereof will be explained.

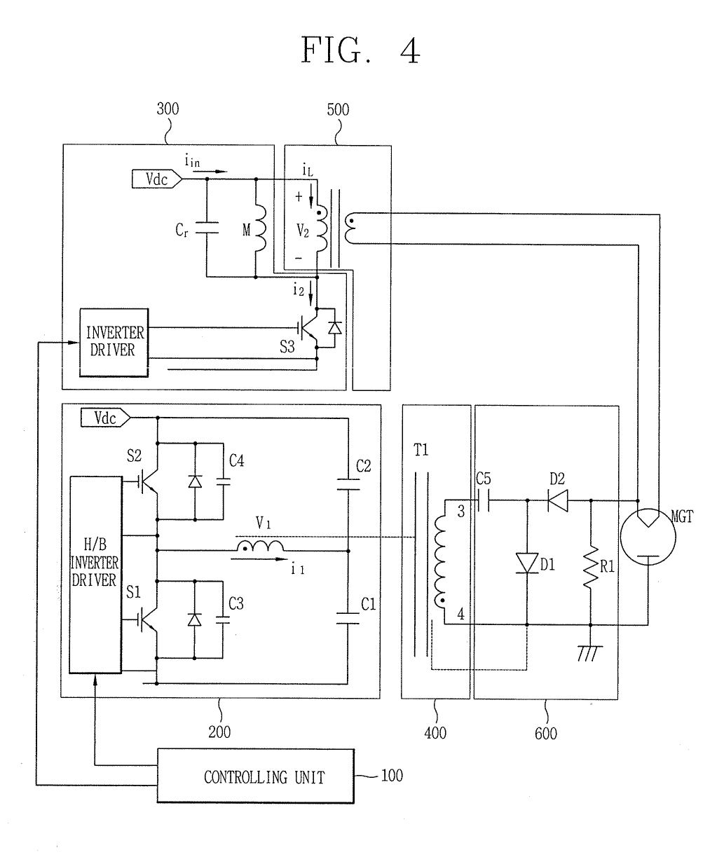

FIG. 4 is a circuit diagram showing a plasma lighting system according to the present invention.

As shown in FIG. 4, the plasma lighting system according to the present invention comprises a controlling unit 100, a first converting unit 300, a second converting unit 200, a first transforming unit 500, a second transforming unit 400, a booster 600 and a magnetron (MGT).

The controlling unit 100 outputs a first switching control signal and a second switching control signal to drive a filament of the magnetron and an anode of the magnetron, respectively.

The controlling unit 100 sequentially outputs the first switching control signal and the second switching control signal with a certain time interval therebetween.

More concretely, the controlling unit 100 outputs the first switching control signal, and then outputs the second switching control signal after the passage of the certain time period, such as, but not limited to approximately five seconds.

The first switching control signal and the second switching control signal are respectively a pulse width modulation signal, and have the same duty cycle.

The first converting unit 300 converts a direct current (DC) voltage into an alternating current (AC) voltage based on the first switching control signal.

In one embodiment, the first converting unit 300 uses a Class-E resonance inverter. However, other types of inverters may be used without departing from the scope or spirit of the present invention.

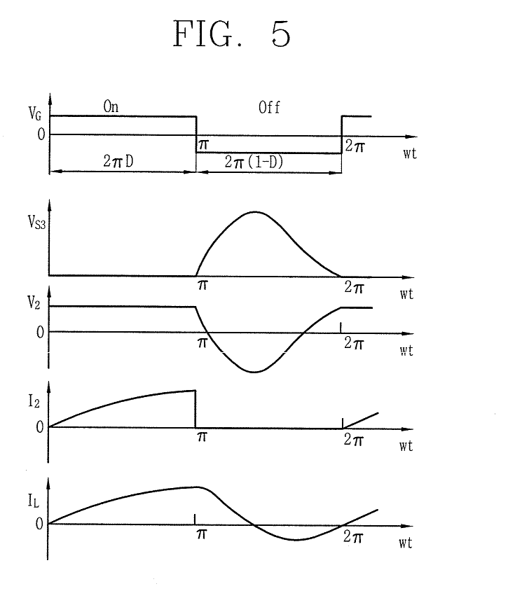

As shown in FIG. 5, when a zero voltage is detected, the Class-E resonance inverter switches a switching device provided therein to minimize a loss of the switching device.

The second converting unit 200 converts a DC voltage into an AC voltage based on the second switching control signal.

In one embodiment, the second converting unit 200 uses a half-bridge inverter. However, it is understood by one skilled in the art that a full-bridge and associated controller 100 may be utilized without departing from the spirit or scope of the present invention.

The first transforming unit 500 transforms the AC voltage converted by the first converting unit 300 into an AC voltage of a preset level, based on a winding ratio of the first transforming unit 500, thereby driving the filament of the magnetron by the AC voltage of a first preset level.

The second transforming unit 400 transforms the AC voltage converted by the second converting unit 200 into an AC voltage of a second preset level, based on a winding ratio of the second transforming unit 400. A booster 600 boosts the AC voltage to a third preset level, thereby driving an anode of the magnetron by the boosted AC voltage.

The plasma lighting system is provided with a power supplying unit (not shown) for supplying an AC power, and a rectifying unit (not shown) for rectifying and smoothing the AC power outputted from the power supplying unit.

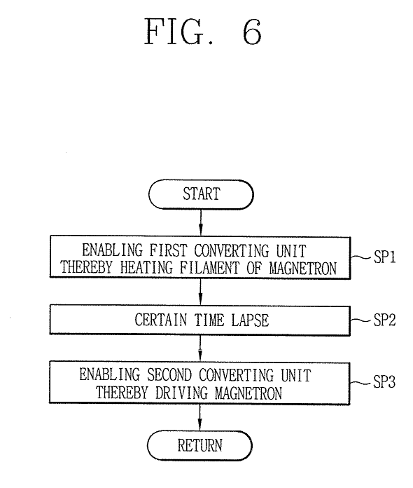

FIG. 6 is a flowchart showing a driving control method for the plasma lighting system according to the present invention.

As shown, a driving control method for a plasma lighting system according to the present invention enables the first converting unit for driving a filament of a magnetron, thereby heating the filament of the magnetron (SP1); and enables a second converting unit for driving the anode of the magnetron after a certain time lapse, thereby generating a microwave (SP2, SP3).

The driving control method will be explained in more detail with reference to FIG. 6.

Once a command for driving the plasma lighting system is inputted, the controlling unit 100 applies a first switching control signal for heating a filament of a magnetron to the first converting unit 300.

Then, the first converting unit 300 switches a switching device provided therein by the first switching control signal, and converts a DC voltage into an AC voltage to apply the converted AC voltage to the first transforming unit 500. The DC voltage is obtained by rectifying and smoothing an AC voltage supplied to a power supplying unit from a rectifying unit (not shown).

The first transforming unit 500 transforms the AC voltage transformed by the first transforming unit 300 into an AC voltage of a preset level, and applies the transformed AC voltage to the filament of the magnetron.

The filament of the magnetron is heated by the transformed AC voltage of a preset level (SP1).

After the filament of the magnetron is heated for a certain time (SP2), the controlling unit 100 applies the second switching control signal to the second converting unit 200 (SP3).

The controlling unit 100 outputs the first switching control signal, and then outputs the second switching control signal after about five seconds. As discussed above, the time period may be varied without departing from the scope or spirit of the present invention.

The second converting unit 200 switches a switching device provided therein by the second switching control signal, and converts a DC voltage into an AC voltage to apply the converted AC voltage to the second transforming unit 400.

The second transforming unit 400 transforms the AC voltage transformed by the second transforming unit 400 into an AC voltage of a preset level. The booster 600 boosts the transformed AC voltage into a high voltage, and applies the boosted high voltage (approximately 4 KV in the disclosed embodiment) to the anode of the magnetron. It is understood that the value of the boosted high voltage may vary without departing from the spirit or scope of the present invention.

The magnetron is then driven by the high voltage, thus generating a microwave (SP3).

As aforementioned, an integral type trans-inverter for implementing both a driving of the filament of the magnetron and a high voltage generation to drive the anode of the magnetron was typically employed. However, in the plasma lighting system and the driving control method thereof according to the present invention, a transformer for driving the filament of the magnetron by heating and a transformer for generating a high voltage to drive the anode of the magnetron are separately operated thus to heat the filament and then to drive the magnetron. Accordingly, the stability of the plasma lighting system is enhanced.

Furthermore, in the plasma lighting system and the driving control method thereof according to the present invention, the transformer for generating a high voltage need not be molded to reduce an insulation distance and to have a light weight. Besides, the number of windings of the transformer for generating a high voltage and the transformer for driving the filament can be freely controlled, thus enhancing the efficiency of the plasma lighting system.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

1. A plasma lighting system, comprising:
a controller which outputs a first switching control signal which drives a filament of a magnetron, and outputs a second switching control signal which drives an anode of the magnetron;
a first converter which converts a direct current (DC) voltage into an alternating current (AC) voltage based on the first switching control signal; and
a second converter which converts a DC voltage into an AC voltage based on the second switching control signal.

2. The plasma lighting system according to claim 1, wherein the controller outputs the first switching control signal and the second switching control signal with a certain time interval therebetween.

3. The plasma lighting system according to claim 2, wherein the controller outputs the first switching control signal, and then outputs the second switching control signal after a certain time.

4. The plasma lighting system according to claim 1, wherein the first switching control signal and the second switching control signal have the same duty cycle.

5. The plasma lighting system according to claim 1, wherein the first converter comprises a Class-E resonance inverter.

6. The plasma lighting system according to claim 1, wherein the second converter comprises a half-bridge inverter.

7. A plasma lighting system, comprising:
a controller which outputs a first switching control signal which drives a filament of a magnetron and a second switching control signal which drives an anode of the magnetron;
a first converter which converts a direct current (DC) voltage into an alternating current (AC) voltage based on the first switching control signal;
a second converter which converts a DC voltage into an AC voltage based on the second switching control signal;
a first transformer which transforms the AC voltage converted by the first converter to a first AC voltage of a preset level, and supplies the filament of the magnetron with the transformed first AC voltage; and
a second transformer which transforms the AC voltage converted by the second converter to a second AC voltage of a preset voltage, and supplies the anode of the magnetron with the transformed second AC voltage.

8. The plasma lighting system according to claim 7, wherein the controller outputs the first switching control signal and the second switching control signal with a certain time interval therebetween.

9. The plasma lighting system according to claim 8, wherein the controller outputs the first switching control signal, and then outputs the second switching control signal after a certain time.

10. The plasma lighting system according to claim 7, wherein the first switching control signal and the second switching control signal have the same duty cycle.

11. The plasma lighting system according to claim 7, wherein the first converter comprises a Class-E resonance inverter.

12. The plasma lighting system according to claim 7, wherein the second converter comprises a half-bridge inverter.

13. A driving control method for a plasma lighting system, comprising:
heating a filament of a magnetron; and
driving an anode of the magnetron when the filament of the magnetron is heated for a certain time, thereby generating microwaves.

14. The method according to claim 13, wherein heating the filament of the magnetron comprises:
generating an alternating current (AC) voltage by a first converter;
transforming the AC voltage generated by the first converter into a voltage of a preset level; and
supplying the transformed voltage of a preset level to the filament of the magnetron.

15. The method according to claim 13, wherein driving the anode of the magnetron comprises:
generating an alternating current (AC) voltage by a second converter;
transforming the AC voltage generated by second converter into a voltage of a preset level;
boosting the transformed voltage of a preset level into a high voltage; and
supplying the high voltage to the anode of the magnetron.

16. The method according to claim 14, wherein the first converter comprises a Class-E resonance inverter.

17. The method according to claim 15, wherein the second converter comprises a half-bridge inverter.

18. A driving control method for a plasma lighting system, comprising:
generating a first alternating current (AC) voltage by a first converter;
transforming the first AC voltage into a first transformed voltage of a preset level;
supplying the first transformed voltage to a filament of a magnetron;
generating a second AC voltage by a second converter when a certain time lapses after generating the first AC voltage;
transforming the second AC voltage into a second transformed voltage of a preset level;
boosting the second transformed voltage into a high voltage; and
supplying an anode of the magnetron with the high voltage, thereby generating microwaves.

19. The method according to claim 18, wherein the first converter comprises a Class-E resonance inverter.

20. The method according to claim 18, wherein the second converter comprises a half-bridge inverter.
